(19) United States
(12) Patent Application Publication
(10) Pub. No.: US 2013/0321316 A1
(43) Pub. Date: Dec. 5, 2013

(54) TOUCH PANEL AND TOUCH DISPLAY DEVICE

(71) Applicant: WINTEK CORPORATION, Taichung City (TW)

(72) Inventors: Yi-Chun Wu, Hualien County (TW); Wun-Yi Shie, Taichung City (TW); Yu-Chen Liu, Taipei City (TW)

(21) Appl. No.: 13/910,107

(22) Filed: Jun. 4, 2013

(30) Foreign Application Priority Data
Jun. 5, 2012 (TW) 101120115

(51) Int. Cl. G06F 3/041

(52) U.S. Cl. CPC G06F 3/041
USPC 345/173

(57) ABSTRACT

A touch panel includes a first substrate, a first axis signal receiving electrode, a second axis signal receiving electrode, and a signal transmitting electrode. The first axis signal receiving electrode is disposed on a first inner surface of the first substrate, and the first axis signal receiving electrode includes a plurality of first sensing electrodes extending along a first direction. The second axis signal receiving electrode is disposed on a side of the first inner surface, and the second axis signal receiving electrode includes a plurality of second sensing electrodes extending along a second direction. The signal transmitting electrode is disposed on the side of the first inner surface. The signal transmitting electrode is used to transmit a touch driving signal. The touch driving signal is received by the first axis signal receiving electrode and the second axis signal receiving electrode.

### BACKGROUND OF THE INVENTION

1. Field of the Invention

The present invention relates to a touch pane and a touch display device, and more particularly, to a touch panel and a touch display device having a three electrode structure which includes one signal transmitting electrode and two different axis electrodes for receiving signals.

2. Description of the Prior Art

In recent years, touch sensing technologies have developed flourishingly, and consumer electronics integrated with touch sensing function are commercialized accordingly. In those consumer electronics, display panels are mainly used to be integrated with the touch sensing function. In other words, the display panels are replaced by the touch display panels with the touch sensing function. According to differences in structure designs, the touch display panels may include an out-cell type touch display panel, an in-cell type touch display panel, and an on-cell type touch display panel. In the out-cell type touch display panel, an independent touch panel is attached to a normal display panel. In the in-cell type touch display panel and the on-cell type touch display panel, touch sensing devices are disposed directly on an inner surface or an outer surface of a substrate in the display panel. The in-cell type touch display panel and the on-cell type touch display panel may be relatively thinner than the out-cell type touch display panel. However, the manufacturing processes of the in-cell type touch display panel and the on-cell type touch display panel are more complicated because additional processes are required to form the touch sensing devices in the display panel, and the yield may become lowered and the manufacturing cost may be increased accordingly.

There are many diverse technologies of touch panel. Capacitive touch technology has become the mainstream touch technology for the high-end and the mid-end consumer electronics, because the capacitive touch panel has advantages such as high precision, and multi-touch property. In the conventional capacitive touch panel, two set of electrodes extending in different axis directions and intersecting to each other are employed. The electrode extending in one axis direction is used to transmit a touch sensing signal, and the electrode extending in another axis direction is used to receive the touch sensing signal. The variations of the received touch sensing signal may be calculated for locating the touch points. Generally, the electrodes extending in different axis directions are made of transparent conductive materials for light transparency consideration. However, the electrical resistivity of the transparent conductive material is generally higher than the electrical resistivity of the metal conductive material, and each of the electrodes has to be kept within a specific width for maintaining appropriate conductivity. The design variation of the electrodes is accordingly limited, and the touch resolution may not be enhanced by simply increasing the number of the electrodes extending in different axis directions.

### SUMMARY OF THE INVENTION

It is one of the objectives of the present invention to provide a touch panel and a touch display device. A three electrode structure, which including one signal transmitting electrode and two different axis signal receiving electrodes, is employed for sensing touch points. The three electrode structure is further integrated with layers in an ordinary display panel in the present invention. The purposes of improving touch sensing effect, enhancing touch resolution, and simplifying the structure and manufacturing process of the touch display device may be accordingly achieved.

To achieve the purposes described above, a preferred embodiment of the present invention provides a touch panel. The touch panel includes a first substrate, a first axis signal receiving electrode, a second axis signal receiving electrode, a first insulation layer, a second insulation layer, and a signal transmitting electrode. The first substrate has a first inner surface and a first outer surface. The first axis signal receiving electrode is disposed on the first inner surface, and the first axis signal receiving electrode includes a plurality of first sensing electrodes extending along a first direction. The second axis signal receiving electrode is disposed on a side of the first inner surface, and the second axis signal receiving electrode includes a plurality of second sensing electrodes extending along a second direction. The first insulation layer is disposed between the first axis signal receiving electrode and the second axis signal receiving electrode. The signal transmitting electrode is disposed on the side of the first inner surface. The second insulation layer is disposed between the second axis signal receiving electrode and the signal transmitting electrode. The signal transmitting electrode is used to transmit a touch driving signal, and the touch driving signal is received by the first axis signal receiving electrode and the second axis signal receiving electrode.

To achieve the purposes described above, a preferred embodiment of the present invention provides a touch display device. The touch display device includes a first substrate, a first axis signal receiving electrode, a second axis signal receiving electrode, a first insulation layer, a second insulation layer, a signal transmitting electrode, and a display panel. The first substrate has a first inner surface and a first outer surface. The first axis signal receiving electrode is disposed on the first inner surface, and the first axis signal receiving electrode includes a plurality of first sensing electrodes extending along a first direction. The second axis signal receiving electrode is disposed on a side of the first inner surface, and the second axis signal receiving electrode includes a plurality of second sensing electrodes extending along a second direction. The first insulation layer is disposed between the first axis signal receiving electrode and the second axis signal receiving electrode. The signal transmitting electrode is disposed on the side of the first inner surface. The second insulation layer is disposed between the second axis signal receiving electrode and the signal transmitting electrode. The signal transmitting electrode is used to transmit a touch driving signal, and the touch driving signal is received by the first axis signal receiving electrode and the second axis signal receiving electrode. The display panel is disposed on the side of the first inner surface. The first axis signal receiving electrode, the second axis signal receiving electrode, the signal transmitting electrode, the first insulation layer, and the second insulation layer are disposed between the first substrate and the display panel.

To achieve the purposes described above, a preferred embodiment of the present invention provides a touch display device. The touch display device includes a first substrate, a second substrate, a first axis signal receiving electrode, a second axis signal receiving electrode, a first insulation layer, a second insulation layer, a signal transmitting electrode, a pixel electrode, and a display medium layer. The first substrate has a first inner surface and a first outer surface. The first axis signal receiving electrode is disposed on the first inner surface, and the first axis signal receiving electrode includes a plurality of first sensing electrodes extending along a first direction. The second axis signal receiving electrode is disposed on a side of the first inner surface, and the second axis signal receiving electrode includes a plurality of second sensing electrodes extending along a second direction. The first insulation layer is disposed between the first axis signal receiving electrode and the second axis signal receiving electrode. The signal transmitting electrode is disposed on the side of the first inner surface. The second insulation layer is disposed between the second axis signal receiving electrode and the signal transmitting electrode. The signal transmitting electrode is used to transmit a touch driving signal, and the touch driving signal is received by the first axis signal receiving electrode and the second axis signal receiving electrode. The second substrate is disposed opposite to the first substrate. The first axis signal receiving electrode, the second axis signal receiving electrode, the signal transmitting electrode, the first insulation layer, the second insulation layer, the pixel electrode, and the display medium layer are disposed between the first substrate and the second substrate. The display medium layer is driven by the first axis signal receiving electrode and the second axis signal receiving electrode through the pixel electrode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch panel according to a first preferred embodiment of the present invention.

FIG. 2 is a schematic diagram illustrating a top view of the touch panel according to the first preferred embodiment of the present invention.

FIG. 3 is a schematic diagram illustrating a touch panel and a touch display device according to a second preferred embodiment of the present invention.

FIG. 4 is a schematic diagram illustrating a touch display device according to a third preferred embodiment of the present invention.

FIG. 5 is a schematic diagram illustrating a touch display device according to a fourth preferred embodiment of the present invention.

FIG. 6 is a schematic diagram illustrating a top view of the touch display device according to the fourth preferred embodiment of the present invention.

FIG. 7 is a schematic diagram illustrating a top view of a touch display device according to another exemplary embodiment of the present invention.

FIG. 8 is a schematic diagram illustrating a touch display device according to a fifth preferred embodiment of the present invention.

### DETAILED DESCRIPTION

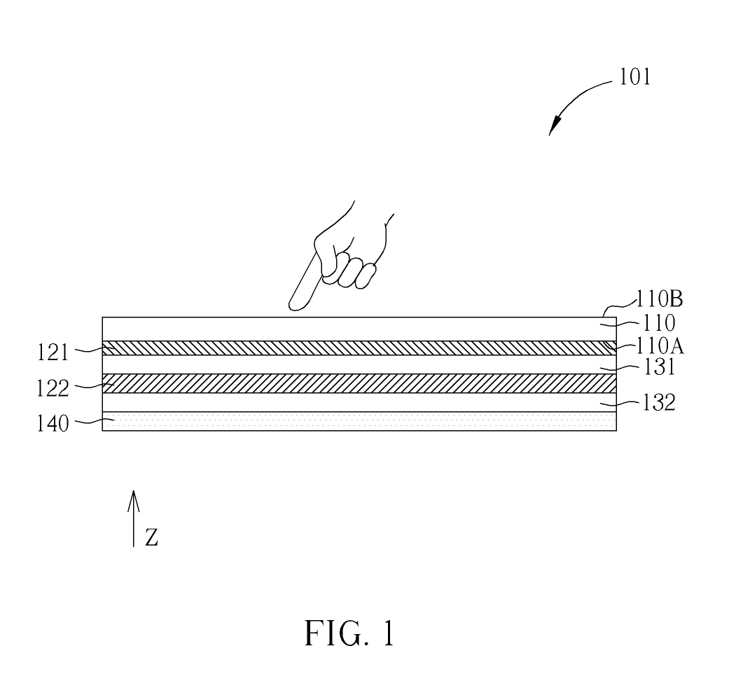

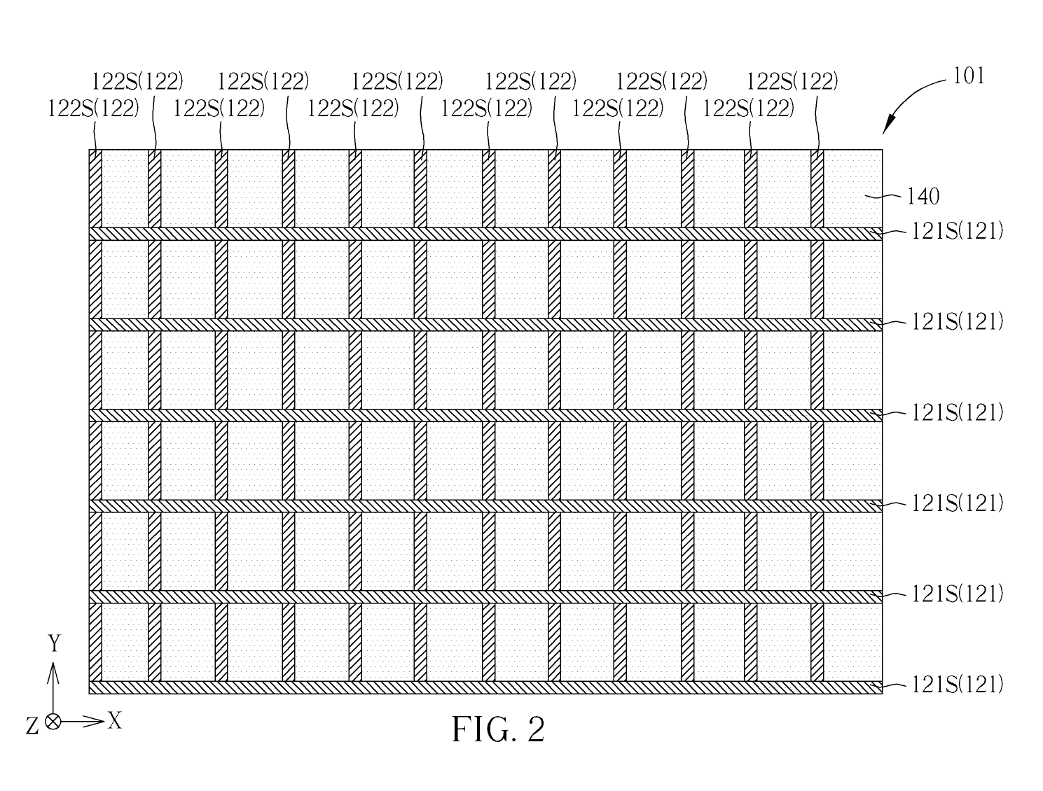

Please refer to FIG. 1 and FIG. 2. FIG. 1 and FIG. 2 are schematic diagrams illustrating a touch panel according to a first preferred embodiment of the present invention. FIG. 1 is a side view diagram and FIG. 2 is a top view diagram. Please note that the figures are only for illustration and the figures may not be to scale. The scale may be further modified according to different design considerations. As shown in FIG. 1 and FIG. 2, the first preferred embodiment of the present invention provides a touch panel 101. The touch panel 101 includes a first substrate 110, a first axis signal receiving electrode 121, a second axis signal receiving electrode 122, a first insulation layer 131, a second insulation layer 132, and a signal transmitting electrode 140. The first substrate 110 has a first inner surface 110A and a first outer surface 110B. The first axis signal receiving electrode 121 is disposed on the first inner surface 110A, and the first axis signal receiving electrode 121 includes a plurality of first sensing electrodes 121S extending along a first direction X. The second axis signal receiving electrode 122 is disposed on a side of the first inner surface 110A, and the second axis signal receiving electrode 122 includes a plurality of second sensing electrodes 1225 extending along a second direction Y. The first direction X is preferably perpendicular to the second direction Y, but not limited thereto. In this embodiment, each of the first sensing electrodes 121S and each of the second sensing electrodes 122S preferably include metal conductive lines, transparent conductive patterns or other appropriate conductive materials. The signal transmitting electrode 140 is preferably a full face transparent electrode, but the present invention is not limited to this. Other kinds of signal transmitting electrodes with different patterns may also be employed in other preferred embodiments. The first insulation layer 131 is disposed between the first axis signal receiving electrode 121 and the second axis signal receiving electrode 122 so as to insulate the first axis signal receiving electrode 121 from the second axis signal receiving electrode 122. The signal transmitting electrode 140 is disposed on the side of the first inner surface 110A. The second insulation layer 132 is disposed between the second axis signal receiving electrode 122 and the signal transmitting electrode 140. In other words, the first axis signal receiving electrode 121, the first insulation layer 131, the second axis signal receiving electrode 122, the second insulation layer 132, and the signal transmitting electrode 140 are preferably stacked in sequence on the first inner surface 110A of the first substrate 110 along a vertical projective direction Z, but not limited thereto.

In this embodiment, the signal transmitting electrode 140 is used to transmit a touch driving signal, and the touch driving signal is received by the first axis signal receiving electrode 121 and the second axis signal receiving electrode 122 respectively. In further description, when a touch object, such as a human finger, touches the first outer surface 110B of the first substrate 110, the electrical condition between the first axis signal receiving electrode 121 and the signal transmitting electrode 140 and the electrical condition between the second axis signal receiving electrode 122 and the signal transmitting electrode 140 may be influenced by the human finger, and signals received by the first axis signal receiving electrode 121 and the second axis signal receiving electrode 122 may be changed accordingly. Variations of the received signals may be calculated to locate the touch position, and the touch positioning function may work accordingly. Additionally, when sensing along the first direction X, the signal transmitting electrode 140 is a driving side, the first axis signal receiving electrode 121 is a sensing side, and the second axis signal receiving electrode 122 is kept in an electrically floating state. Comparatively, when sensing along the second direction Y, the signal transmitting electrode 140 is the driving side, the second axis signal receiving electrode 122 is the sensing side, and the first axis signal receiving electrode 121 is kept in an electrically floating state. In other words, a sensing time point of the first axis signal receiving electrode 121 is preferably separated from a sensing time point of the second axis signal receiving electrode 122. In addition, each of the first sensing electrodes 121S is preferably driven respectively for sensing sequentially, and each of the second sensing electrodes 122S is also preferably driven respectively for sensing sequentially so as to avoid misjudgment under multi point touch sensing operation. Related problems such as ghost points may be accordingly improved. The above-mentioned touch sensing method may be regarded as a kind of mutual capacitance touch sensing method, but not limited thereto. Additionally, the first axis signal receiving electrode 121, the second axis signal receiving electrode 122, and the signal transmitting electrode 140 in the touch panel 101 may be regarded as a three electrode structure, but not limited thereto. The first sensing electrodes 121S and the second sensing electrodes 122S may be metal conductive lines, and the amount of the first sensing electrodes 121 S and the second sensing electrodes 122S may be relatively increased by reducing line widths of the first sensing electrodes 121S and the second sensing electrodes 122S. The touch sensing performance and the touch resolution of the touch panel 101 may be accordingly enhanced.

The following description will detail the different embodiments in the present invention. To simplify the description, identical components in each of the following embodiments are marked with identical symbols. For making it easier to understand the differences between the embodiments, the following description will detail the dissimilarities among different embodiments and the identical features will not be redundantly described.

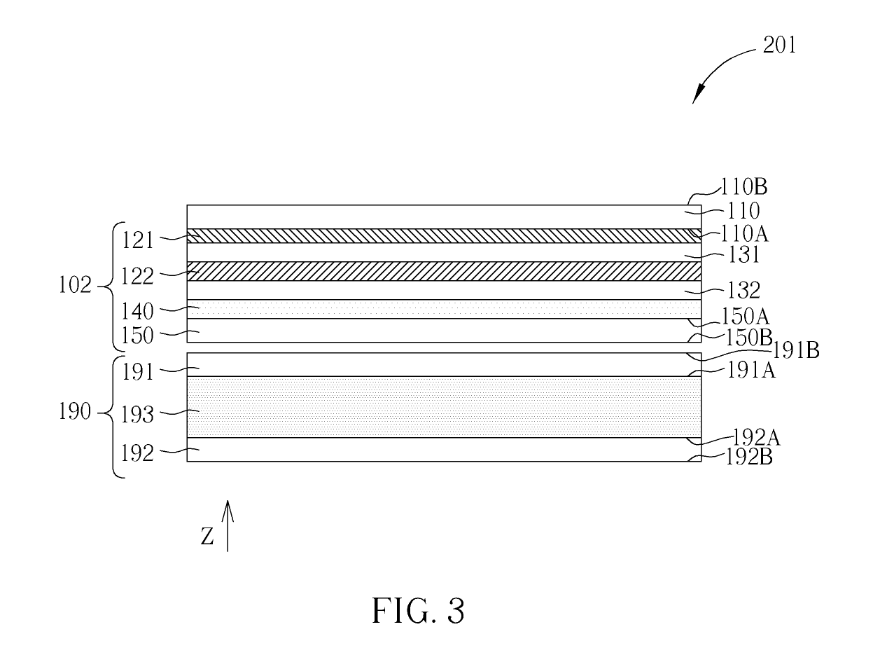

Please refer to FIG. 3. FIG. 3 is a schematic diagram illustrating a touch panel and a touch display device according to a second preferred embodiment of the present invention. As shown in FIG. 3, the second preferred embodiment of the present invention provides a touch panel 102. The difference between the touch panel 102 of this embodiment and the touch panel 101 of the first preferred embodiment is that the touch panel 102 further includes a second substrate 150. The second substrate 150 is disposed opposite to the first substrate 110. The second substrate 150 has a second inner surface 150A and a second outer surface 150B. The second inner surface 150A faces the first inner surface 110A of the first substrate 110. The first axis signal receiving electrode 121, the second axis signal receiving electrode 122, the signal transmitting electrode 140, the first insulation layer 131, and the second insulation layer 132 are disposed between the first substrate 110 and the second substrate 150. Apart from the second substrate 150 in this embodiment, the other components, allocations, material properties, and the touch sensing method in this embodiment are similar to those of the touch panel 101 in the first preferred embodiment detailed above and will not be redundantly described.

As shown in FIG. 3, the second preferred embodiment of the present invention provides a touch display device 201. The touch display device 201 includes the touch panel 102 mentioned above and a display panel 190. The display panel 190 is disposed on the side of the first inner surface 110A of the first substrate 110. The second substrate 150 is disposed between the display panel 190 and the signal transmitting electrode 140. The display panel 190 includes a third substrate 191, a fourth substrate 192, and a display medium layer 193. The third substrate 191 and the fourth substrate 192 are disposed oppositely to each other. The third substrate 191 has a third inner surface 191A and a third outer surface 191B. The fourth substrate 192 has a fourth inner surface 192A and a fourth outer surface 192B. The third inner surface 191A faces the fourth inner surface 192A. The display medium layer 193 is disposed between the third substrate 191 and the fourth substrate 192. In this embodiment, the display panel 190 may preferably include a liquid crystal display panel, an organic light emitting diode (OLED) display panel, an electro-wetting display panel, an e-link display panel, a plasma display panel, or a field emission display (FED) panel, but not limited thereto. Accordingly, the display medium layer 193 may include liquid crystal material, organic light emitting material, ink, electro ink, or plasma material, but not limited thereto. In the touch display device 201, the touch panel 102 is disposed on a side of the third outer surface 191B of the third substrate 191. The first outer surface 110B of the touch panel 102 may be a touch surface, and the third outer surface 191B or the fourth outer surface 192B of the display panel 190 may be designed as a display surface according to different design considerations. Therefore, the touch display device 201 in this embodiment may be regarded as a kind of the out-cell touch display device, but not limited thereto.

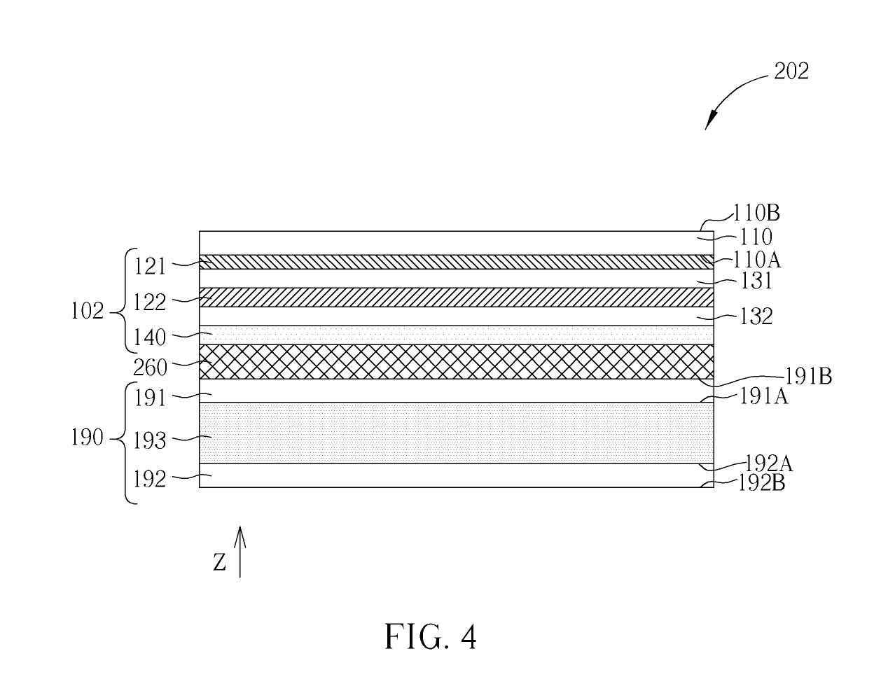

Please refer to FIG. 4. FIG. 4 is a schematic diagram illustrating a touch display device according to a third preferred embodiment of the present invention. As shown in FIG. 4, the third preferred embodiment of the present invention provides a touch display device 202. The difference between the touch display device 202 of this embodiment and the touch display device 201 of the second preferred embodiment is that the touch display device 202 includes the touch panel 101, the display panel 190, and an adhesive layer 260. The adhesive layer 260 is disposed between the touch panel 101 and the display panel 190 so as to combine the touch panel 101 and the display panel 190. The adhesive layer 260 may completely cover the third outer surface 191B for combining the touch panel 101 and the display panel 190 or partially cover edges of the third outer surface 191B for combining the touch panel 101 and the display panel 190. Apart from the adhesive layer 260 in this embodiment, the other components, allocations, material properties, and the touch sensing method in this embodiment are similar to those of the touch display device 201 in the second preferred embodiment detailed above and will not be redundantly described. It is worth noting that in other preferred embodiments of the present invention, the signal transmitting electrode 140 may also be disposed directly on the third outer surface 191B of the third substrate 191.

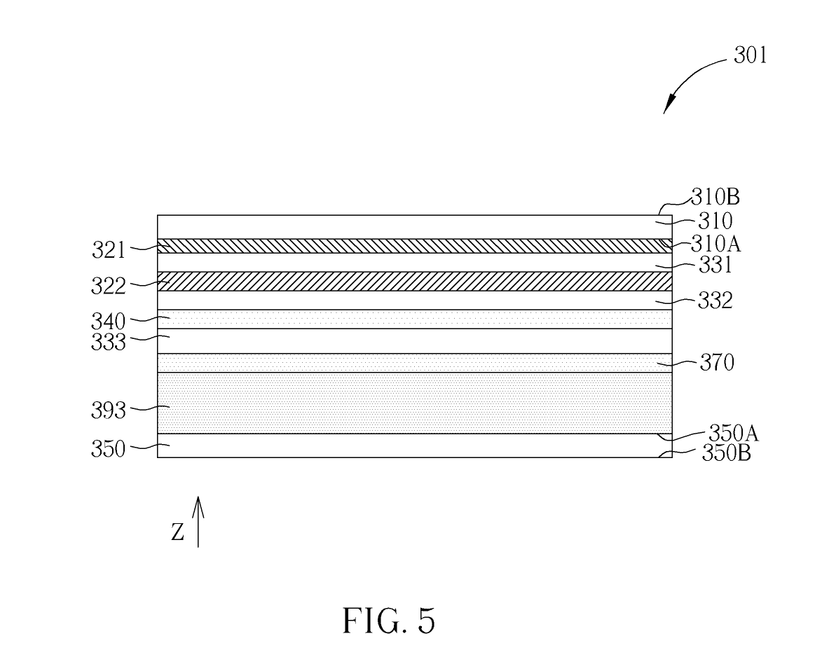

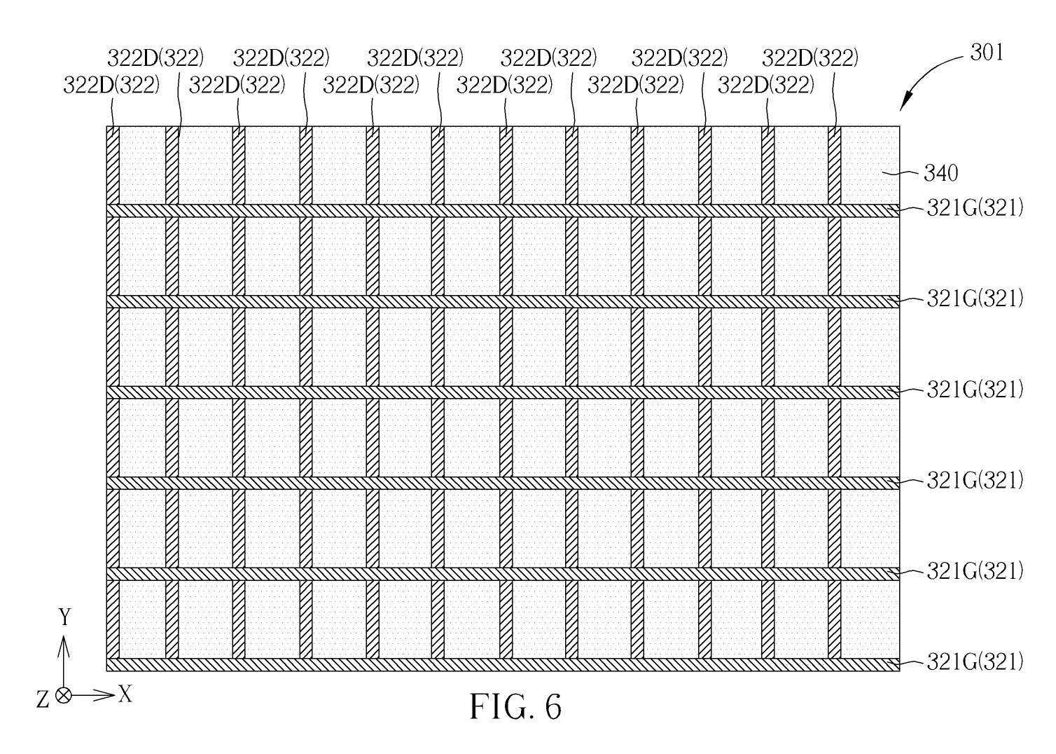

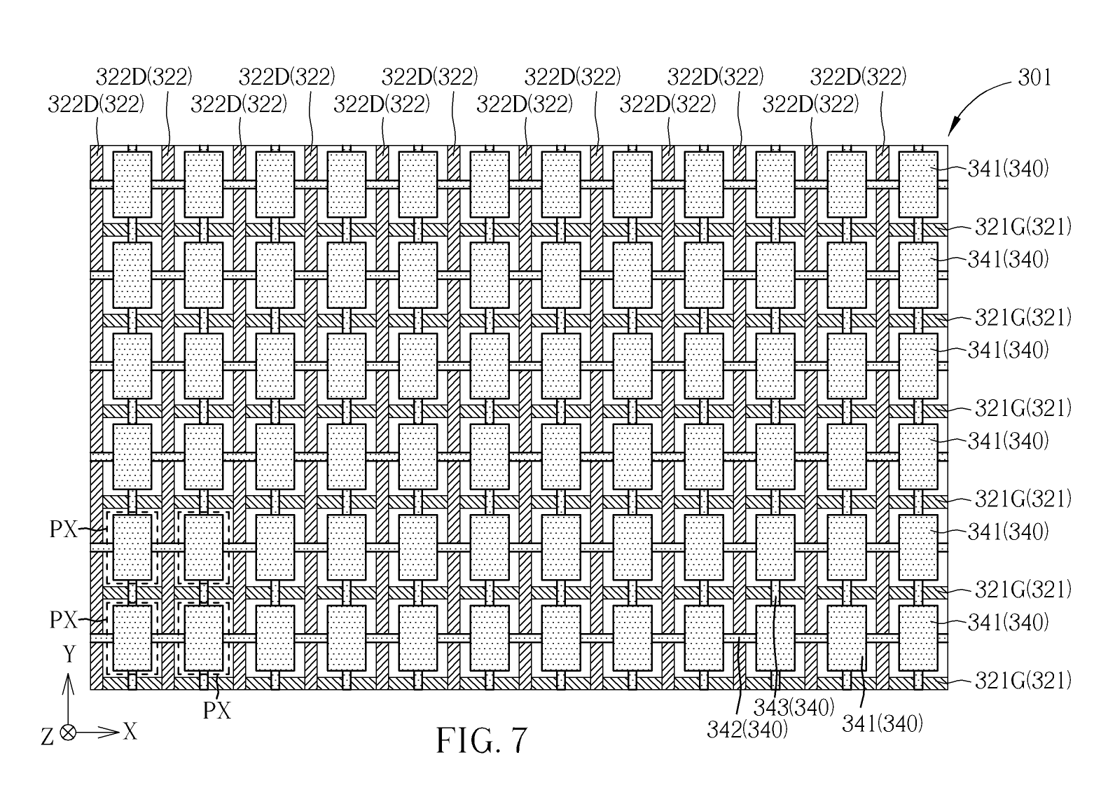

Please refer to FIGS. 5-7. FIG. 5 is a schematic diagram illustrating a touch display device according to a fourth preferred embodiment of the present invention. FIG. 6 is a schematic diagram illustrating a top view of the touch display device according to the fourth preferred embodiment of the present invention. FIG. 7 is a schematic diagram illustrating a top view of a touch display device according to another exemplary embodiment of the present invention. As shown in FIG. 5 and FIG. 6, the fourth preferred embodiment of the present invention provides a touch display device 301. The touch display device 301 includes a first substrate 310, a second substrate 350, a first axis signal receiving electrode 321, a second axis signal receiving electrode 322, a first insulation layer 331, a second insulation layer 332, a third insulation layer 333, a signal transmitting electrode 340, a pixel electrode 370, and a display medium layer 393. The first substrate 310 has a first inner surface 310A and a first outer surface 310B. The second substrate 350 is disposed opposite to the first substrate 310. The second substrate 350 has a second inner surface 350A and a second outer surface 350B. The second inner surface 350A faces the first inner surface 310A. The first axis signal receiving electrode 321, the second axis signal receiving electrode 322, the signal transmitting electrode 340, the first insulation layer 331, the second insulation layer 332, the third insulation layer 333, the pixel electrode 370, and the display medium layer 393 are disposed between the first substrate 310 and the second substrate 350. The first axis signal receiving electrode 321 is disposed on the first inner surface 310A, and the first axis signal receiving electrode 321 includes a plurality of first sensing electrodes 321G extending along the first direction X. The second axis signal receiving electrode 322 is disposed on a side of the first inner surface 310A, and the second axis signal receiving electrode 322 includes a plurality of second sensing electrodes 322D extending along the second direction Y. The first insulation layer 331 is disposed between the first axis signal receiving electrode 321 and the second axis signal receiving electrode 322. The signal transmitting electrode 340 is disposed on the side of the first inner surface 310A. The second insulation layer 332 is disposed between the second axis signal receiving electrode 322 and the signal transmitting electrode 340. The signal transmitting electrode 340 is disposed between the display medium layer 393 and the first substrate 310. The third insulation layer 333 is disposed between the pixel electrode 370 and the signal transmitting electrode 340.

In this embodiment, the signal transmitting electrode 340 is used to transmit a touch driving signal, and the touch driving signal is received by the first axis signal receiving electrode 321 and the second axis signal receiving electrode 322. The touch sensing method of the touch display device 301 in this embodiment is similar to the above-mentioned touch sensing method of the touch panel 101 in the first preferred embodiment. When sensing along the first direction X, the signal transmitting electrode 340 is a driving side, the first axis signal receiving electrode 321 is a sensing side, and the second axis signal receiving electrode 322 is kept in an electrically floating state. Comparatively, when sensing along the second direction Y, the signal transmitting electrode 340 is the driving side, the second axis signal receiving electrode 322 is the sensing side, and the first axis signal receiving electrode 321 is kept in an electrically floating state. In other words, a sensing time point of the first axis signal receiving electrode 321 is preferably separated from a sensing time point of the second axis signal receiving electrode 322. In addition, each of the first sensing electrodes 321G is preferably driven respectively for sensing sequentially, and each of the second sensing electrodes 322D is also preferably driven respectively for sensing sequentially so as to avoid misjudgment under the multi point touch sensing operation. The related problems such as ghost points may be accordingly improved. It is worth noting that each of the first sensing electrodes 321G is preferably a gate line, each of the second sensing electrodes 322D is preferably a data line, and the first substrate 310 is preferably an array substrate, but not limited thereto. The display medium layer 393 is driven by each of the first sensing electrodes 321G of the first axis signal receiving electrode 321 and each of the second sensing electrodes 322D of the second axis signal receiving electrode 322 through the pixel electrode 370. In other words, in the touch display device 301 of this embodiment, the first sensing electrodes 321G and the second sensing electrodes 322D, which are employed for touch sensing, are also employed as gate lines and data lines in an ordinary array substrate. Accordingly, each of the first sensing electrodes 321G and each of the second sensing electrodes 322D may also be used to deliver gate line signals and data line signals so as to control the pixel electrode 370 through a switching device (not shown). Additionally, the signal transmitting electrode 340 in this embodiment may preferably be a transparent common electrode. The display medium layer 393 may be driven by the pixel electrode 370 and the signal transmitting electrode 340, which acts as the common electrode, for providing display effects. The display medium layer 393 may include liquid crystal material, organic light emitting material, ink, electro ink, or plasma material, but not limited thereto.

Since the first sensing electrodes 321G and the second sensing electrodes 322D may be the metal conductive lines on the ordinary array substrate, the structure and the manufacturing process of the touch display device 301 may be simplified due to the integration of the gate lines, the data lines, and the signal receiving electrodes. The touch sensing performance of the touch display device 301 may also be enhanced because the resistance of each of the signal receiving electrodes is decreased. For example, in an ordinary display device, a line width of a metal conductive line on an array substrate is around a few micrometers. A normal touch object may completely cover a width of one first sensing electrode 321 G and a width of one second sensing electrode 322D accordingly so as to enhance the signal variation influenced by the touch object. Additionally, the amount of the first sensing electrodes 321 G and the second sensing electrodes 322D may be equal to the gate lines and the data lines, which are used for displaying images. The touch resolution may be therefore enhanced. In this embodiment, the structure of the touch display device 301 may be used for a fringe field switching (FFS) liquid crystal driving method, but the present invention is not limited to this. In other preferred embodiments of the present invention, the material and driving method of the display medium layer 393 may be further modified to generate other display effects. In the touch display device 301, the first outer surface 310B is preferably a touch surface, and the first outer surface 310B or the second outer surface 350B may be designed as a display surface according to different design considerations.

As shown in FIG. 6, the signal transmitting electrode 340 is preferably a full face transparent electrode, but the present invention is not limited to this. As shown in FIG. 7, in another exemplary embodiment of the present invention, the signal transmitting electrode 340 may include a plurality of sub electrode patterns 341 respectively disposed in pixel regions PX defined by the first sensing electrodes 321G and the second sensing electrodes 322D intersecting to each other. In addition, the signal transmitting electrode 340 may further include a plurality of first connecting lines 342 and a plurality of second connecting lines 343. Each of the first connecting lines 342 is used to electrically connect two adjacent sub electrode patterns 341 disposed along the first direction X, and each of the second connecting lines 343 is used to electrically connect two adjacent sub electrode patterns 341 disposed along the second direction Y. Each of the sub electrode patterns 341 is preferably a transparent conductive pattern. The first connecting lines 342 and the second connecting lines 343 may be metal conductive lines or be made of transparent conductive materials according to different considerations. All of the sub electrode patterns 341 in the signal transmitting electrode 340 may be electrically connected to each other through the first connecting lines 342 and the second connecting lines 343, and the method of proving the touch driving signals to the signal transmitting electrode 340 may be accordingly simplified, but not limited thereto. In other preferred embodiments of the present invention, only some of the sub electrode patterns 341 in the signal transmitting electrode 340 are electrically connected to each other so as to compatible with the display driving design.

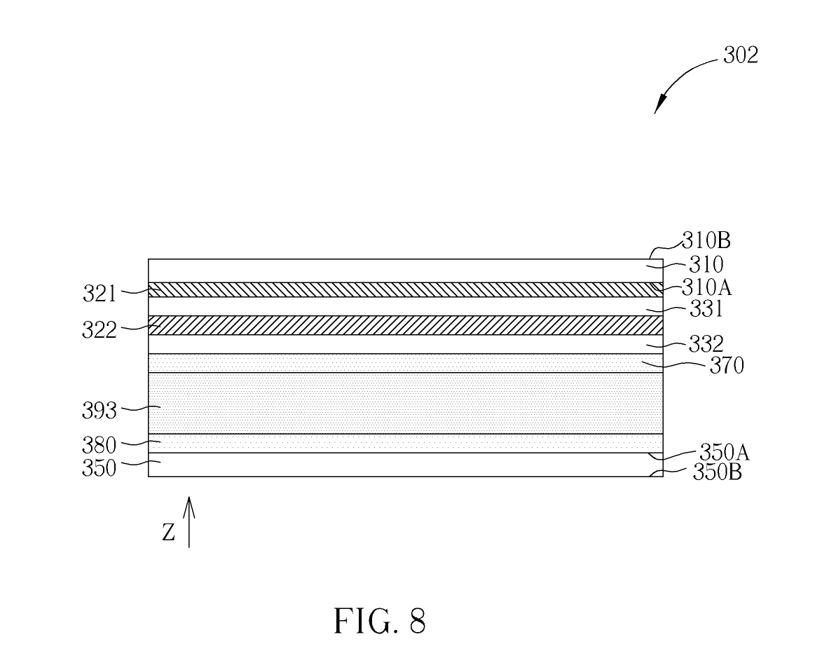

Please refer to FIG. 8. FIG. 8 is a schematic diagram illustrating a touch display device according to a fifth preferred embodiment of the present invention. As shown in FIG. 8, the fifth preferred embodiment of the present invention provides a touch display device 302. The difference between the touch display device 302 of this embodiment and the touch display device 301 of the fourth preferred embodiment is that the touch display device 302 includes a signal transmitting electrode 380 disposed between the display medium layer 393 and the second substrate 350. The material property and the shape of the signal transmitting electrode 380 are similar to those of the signal transmitting electrode 340 in the fourth preferred embodiment. In other words, the signal transmitting electrode 380 may also be a transparent common electrode. The display medium layer 393 may be driven by the pixel electrode 370 and the signal transmitting electrode 380, which is used as a common electrode, so as to present display effects. Additionally, the signal transmitting electrode 380 is used to transmit the touch driving signal, and the touch driving signal is received by the first axis signal receiving electrode 321 and the second axis signal receiving electrode 322 respectively. Apart from the signal transmitting electrode 380 in this embodiment, the other components, allocations, material properties, and the touch sensing method in this embodiment are similar to those of the touch display device 301 in the fourth preferred embodiment detailed above and will not be redundantly described.

To summarize the above descriptions, in the touch panel of the present invention, a three electrode structure, which including one signal transmitting electrode and two different axis signal receiving electrodes, is employed for sensing touch points. The purpose of improving touch sensing performance may be accordingly achieved. In addition, conventional layers in an ordinary display panel function as the signal transmitting electrode and the two different axis signal receiving electrodes. The purposes of enhancing touch resolution, and simplifying the structure and manufacturing process of the touch display device may be accordingly achieved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch panel, comprising:
a first substrate, having a first inner surface and a first outer surface;
a first axis signal receiving electrode, disposed on the first inner surface, wherein the first axis signal receiving electrode comprises a plurality of first sensing electrodes extending along a first direction;
a second axis signal receiving electrode, disposed on a side of the first inner surface, wherein the second axis signal receiving electrode comprises a plurality of second sensing electrodes extending along a second direction, and the first axis signal receiving electrode is insulated from the second axis signal receiving electrode;
a signal transmitting electrode, disposed on the side of the first inner surface, wherein the signal transmitting electrode is used to transmit a touch driving signal, and the touch driving signal is received by the first axis signal receiving electrode and the second axis signal receiving electrode.

2. The touch panel of claim 1, further comprising:
a first insulation layer, disposed between the first axis signal receiving electrode and the second axis signal receiving electrode; and
a second insulation layer, disposed between the second axis signal receiving electrode and the signal transmitting electrode.

3. The touch panel of claim 1, wherein each of the first sensing electrodes is a metal conductive line and each of the second electrodes is a metal conductive line.

4. The touch panel of claim 1, wherein the first direction is perpendicular to the second direction.

5. The touch panel of claim 1, wherein the signal transmitting electrode is a driving side, the first axis signal receiving electrode is a sensing side, and the second axis signal receiving electrode is kept in an electrically floating state when sensing along the first direction.

6. The touch panel of claim 1, wherein the signal transmitting electrode is a driving side, the second axis signal receiving electrode is a sensing side, and the first axis signal receiving electrode is kept in an electrically floating state when sensing along the second direction.

7. The touch panel of claim 2, further comprising a second substrate disposed opposite to the first substrate, wherein the first axis signal receiving electrode, the second axis signal receiving electrode, the signal transmitting electrode, the first insulation layer, and the second insulation layer are disposed between the first substrate and the second substrate.

8. A touch display device, comprising:
a first substrate, having a first inner surface and a first outer surface;
a first axis signal receiving electrode, disposed on the first inner surface, wherein the first axis signal receiving electrode comprises a plurality of first sensing electrodes extending along a first direction;
a second axis signal receiving electrode, disposed on a side of the first inner surface, wherein the second axis signal receiving electrode comprises a plurality of second sensing electrodes extending along a second direction, and the first axis signal receiving electrode is insulated from the second axis signal receiving electrode;
a signal transmitting electrode, disposed on the side of the first inner surface, wherein the signal transmitting electrode is used to transmit a touch driving signal, and the touch driving signal is received by the first axis signal receiving electrode and the second axis signal receiving electrode; and
a display panel, disposed on the side of the first inner surface, wherein the first axis signal receiving electrode, the second axis signal receiving electrode and the signal transmitting electrode are disposed between the first substrate and the display panel.

9. The touch display device of claim 8, further comprising:
a first insulation layer, disposed between the first axis signal receiving electrode and the second axis signal receiving electrode; and
a second insulation layer, disposed between the second axis signal receiving electrode and the signal transmitting electrode.

10. The touch display device of claim 8, further comprising a second substrate disposed between the display panel and the signal transmitting electrode.

11. A touch display device, comprising:
a first substrate, having a first inner surface and a first outer surface;
a first axis signal receiving electrode, disposed on the first inner surface, wherein the first axis signal receiving electrode comprises a plurality of first sensing electrodes extending along a first direction;
a second axis signal receiving electrode, disposed on a side of the first inner surface, wherein the second axis signal receiving electrode comprises a plurality of second sensing electrodes extending along a second direction;
a first insulation layer, disposed between the first axis signal receiving electrode and the second axis signal receiving electrode;
a signal transmitting electrode, disposed on the side of the first inner surface, wherein the signal transmitting electrode is used to transmit a touch driving signal, and the touch driving signal is received by the first axis signal receiving electrode and the second axis signal receiving electrode;
a second insulation layer, disposed between the second axis signal receiving electrode and the signal transmitting electrode;
a second substrate, disposed opposite to the first substrate, wherein the first axis signal receiving electrode, the second axis signal receiving electrode, the signal transmitting electrode, the first insulation layer, and the second insulation layer are disposed between the first substrate and the second substrate;
a pixel electrode, disposed between the first substrate and the second substrate; and
a display medium layer, disposed between the pixel electrode and the second substrate, wherein the display medium layer is driven by the first axis signal receiving electrode and the second axis signal receiving electrode through the pixel electrode.

12. The touch display device of claim 11, wherein the first substrate include an array substrate.

13. The touch display device of claim 11, wherein each of the first sensing electrodes includes a gate line and each of the second electrodes includes a data line.

14. The touch display device of claim 11, wherein the signal transmitting electrode includes a transparent common electrode disposed between the display medium layer and the first substrate.

15. The touch display device of claim 11, wherein the signal transmitting electrode includes a transparent common electrode disposed between the display medium layer and the second substrate.

16. The touch display device of claim 11, wherein the first direction is perpendicular to the second direction.

17. The touch display device of claim 11, wherein the signal transmitting electrode is a driving side, the first axis signal receiving electrode is a sensing side, and the second axis signal receiving electrode is kept in an electrically floating state when sensing along the first direction.

18. The touch display device of claim 11, wherein the signal transmitting electrode is a driving side, the second axis signal receiving electrode is a sensing side, and the first axis signal receiving electrode is kept in an electrically floating state when sensing along the second direction.
